(19) United States
(12) Patent Application Publication
(10) Pub. No.: US 2026/0170976 A1
(43) Pub. Date: Jun. 18, 2026

(54) LED LIGHTING DEVICE AND METHOD FOR ASSEMBLING LED LIGHTING DEVICE

(71) Applicant: Bitro Group, Inc., Hackensack, NJ (US)

(72) Inventor: Ketak AN, Paramus, NJ (US)

(73) Assignee: Bitro Group, Inc., Hackensack, NJ (US)

(21) Appl. No.: 19/421,963

(22) Filed: Dec. 16, 2025

Related U.S. Application Data
(60) Provisional application No. 63/734,964, filed on Dec. 17, 2024.

(51) Int. Cl. G09F 13/04; F21V 3/02; F21V 17/10; F21Y 115/10

(52) U.S. Cl. CPC G09F 13/0445; F21V 3/02; F21V 17/101; G09F 13/0413; F21Y 2115/10

(57) ABSTRACT

A method includes providing a frame for a lighting device including an elongated sheet of frame material bent across at its width at at least one location to form a shape. A first end meets a second end of the sheet at a seem and approaches the seem at an angle relative to the second end. The frame has a protrusion extending from an inner surface adjacent a front or back edge of the shape. The method includes providing a sheet of joint material having a first thickness, providing a groove in the joint material defining a reduced second thickness and dividing a first segment and a second segment, bending the joint material at the groove, positioning the first segment adjacent the first end of the sheet of frame material and the second segment adjacent the second end, and securing the joint material with fasteners. Each fastener pierces the protrusion.

### CROSS REFERENCE TO RELATED APPLICATIONS

This application takes priority from U.S. Provisional Patent Application No. 63/734,964, filed Dec. 17, 2024, the entire contents of which are incorporated by reference herein.

### FIELD OF THE INVENTION

The invention relates to LED lighting devices, specifically for use in shaped LED displays, such as channel letters and other signage, for securing seems and controlling light leakage.

### BACKGROUND

Light Emitting Diode (LED) lighting devices, such as those used in signage, often include shaped housing configurations to provide desirable aesthetics for lighting. For example, LED signage may be provided in the shape of letters or a corporate logo. In the case of letters, such signage components are often referred to as channel letters, which provide internal channels for incorporating LED lighting.

Channel letters are typically then provided with a translucent front panel that modifies one or more qualities of the light output by the LED lighting device. Such a translucent front panel may then control light diffusion, determining how evenly lit the front panel is, as well as a color and amount of light output by the signage.

A frame, or housing, for such a channel letter or design is typically formed from an elongated sheet of material bent to the shape desired and sized such that after bending, two ends of the sheet of material meet at a seem. The seem must then be secured in a way that prevents light from leaking out of the frame, while also avoiding any internal shadows. Light leaking out of the frame would damage the visual and aesthetic effect of the finished product, while internal shadows would result in shadows on the translucent front panel, which would in turn result in dark spots and inconsistent lighting of the front surface of the lighting device.

Seems for such channel letters are typically located at corners, so as to avoid unnecessary bends in the channel letter frame while hiding slight inconsistencies between the two ends. However, this results in a need for rigidly securing the seem of each letter or shape formed at an angle, while the necessary angle is likely to be different from shape to shape or from letter to letter.

Typically, in assembling such channel letters, a scored metal shim is provided for bending to shape and overlaying an internal surface of the seem. Each shim is then bent to the precise shape needed prior to applying the shim to the housing and is then applied to the inner surface using an adhesive. A quick drying or instant drying adhesive is typically required so as to avoid a need for clamping the frame housing while the adhesive sets. Such an adhesive is typically a quick-drying epoxy mixture, which must therefore be mixed immediately prior to fixation.

As a result, the existing process requires that all shims to be placed must be carefully prepared individually by bending each to the correct angle, and the epoxy must then be mixed and applied within approximately 30 seconds. Further, if excess epoxy is applied, such adhesive may itself result in shadows in a finished product. Accordingly, the existing process is time consuming even for experienced workers, requires substantial preparation, must be done in small batches, and still leads to inconsistent results.

While these challenges are described in the context of channel letters, such challenges also exist in other shaped lighting houses, including in the context of lighting in the shape of corporate logos or in geometric shapes. There is therefore a need for an improved process for assembling channel letters.

There is a further need for such a process in which no adhesive or glue is required, or in which only minimal adhesive is used. There is a further need for such a process in which light leakage is prevented at a seem of the frame. There is a further need for such a process in which tools and materials used are affordable and in which molds need not be created.

There is a further need for such a process in which components used are flexible and versatile for joining seems at varied angles. There is a further need for such a process and for corresponding components in which shadows are avoided.

### SUMMARY

A method is provided for assembly an LED lighting device. The method includes providing a frame for the LED lighting device, the frame including at least one elongated sheet of frame material bent across at its width at at least one location to form a shape.

A first end of the sheet of frame material meets a second end of the sheet of frame material at a seem, and the first end of the sheet of frame material approaches the seem at an angle relative to the second end of the sheet of frame material. The frame has at least one protrusion extending from an inner surface defined by the sheet of frame material towards an inside of the shape adjacent a front or back edge of the shape.

The method then includes providing a sheet of joint material having a first thickness, providing a groove in the sheet of joint material, the groove defining a reduced second thickness and dividing a first segment of the sheet of joint material and a second segment of the sheet of joint material, bending the sheet of joint material at the groove and positioning the first segment adjacent the first end of the sheet of frame material and positioning the second segment adjacent the second end of the sheet of frame material, and securing the sheet of joint material on each of the first and second ends of the sheet of frame material with a plurality of fasteners. Each of the plurality of fasteners pierces the protrusion of the frame and retains a corresponding segment of the first segment and the second segment relative to the protrusion.

In some embodiments, the shape is a shape of a letter. In some such embodiments, the frame material is a flexible metal, and the metal is bent across its width at multiple locations to define the shape of the letter.

In some embodiments, the frame material is aluminum.

In some embodiments, the joint material is polycarbonate. In some such embodiments, the joint material is laminated on a surface opposite the groove with at least one layer of opaque material. In some such embodiments, the opaque material is vinyl.

In some embodiments utilizing an opaque material, an inward facing surface of the opaque material is white or silver and an outward facing surface of the opaque material is black. In some such embodiments, the joint material is translucent.

In some embodiments, the groove applied to the sheet of joint material is rectangular, round, or V-shaped.

In some embodiment, the fasteners are micro-pin nails. In some embodiments, the first thickness is sufficient to receive the micro-pin nails but the second thickness is insufficient to receive the micro-pin nails.

In some embodiments, the method includes applying a layer of tape to the seem prior to securing the sheet of joint material.

In some embodiments, the frame has a substantially consistent cross-sectional profile matching the shape other than the at least one protrusion, and the at least one protrusion is a first protrusion extending from the inner surface towards the inside of the shape adjacent the front edge of the shape and a second protrusion extending from the inner surface towards the inside of the shape adjacent the back edge of the shape, and fasteners are applied at each of the first and second protrusion.

In some embodiments, the frame houses at least one LED lighting module.

### BRIEF DESCRIPTION OF THE DRAWINGS

FIG. 1 is a first example of LED lighting devices in accordance with this disclosure.

FIGS. 2-4 illustrate the preparation of one embodiment of an LED lighting assembly for us in the method of this disclosure.

FIG. 5 shows a frame for an LED lighting device in accordance with this disclosure.

FIGS. 6, 7, 8A, and 8B show a sheet of joint material for use in the method described.

FIG. 9 shows a detail view of a groove cut into the sheet of joint material of FIG. 6.

FIG. 10 shows a portion of the sheet of joint material of FIG. 6 cut to size and bent to shape.

FIG. 11 shows the portion of the sheet of joint material of FIG. 10 positioned on the frame.

FIGS. 12 and 13 show the securing of the portion of the sheet of joint material of FIG. 10 to the frame.

FIG. 14 shows the portion of the sheet of joint material secured to the frame.

FIGS. 15 and 16 show an additional instance of joint material secured to a frame in accordance with this disclosure.

FIGS. 17A, B and 18A, B show alternate embodiments of sheets of joint material for use in the method described.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

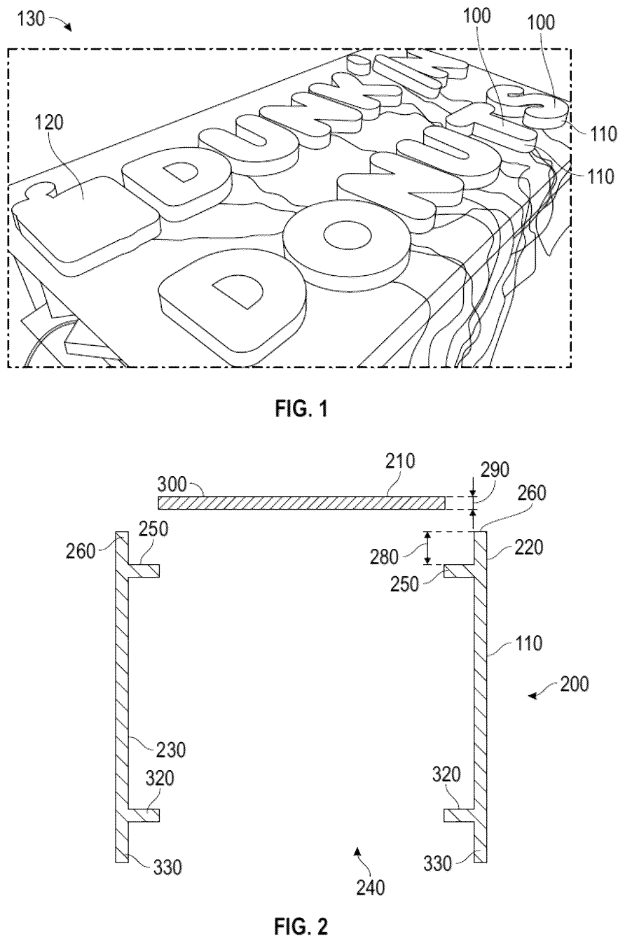

FIG. 1 is a first example of LED lighting devices 100 assembled in accordance with this disclosure.

As shown, the LED lighting devices 100 each have a frame 110 that forms a shape. When viewed from a front surface, the frame 110 of each such lighting device 100 is often provided in the shape of a letter, such that the frame is an extrusion forming an outline of the desired letter. Similarly, a frame may form a shape of a logo design, or a portion of a corporate logo design 120. The lighting devices 100 then combine to form a complete sign which may spell out words or illustrate a logo design.

As shown, each LED lighting device 100 may be one of several such devices in a set 130, with each device taking the shape of a different letter or associated shape.

The frame 110 may be formed from a variety of metals, including aluminum. As such, the frame 110 may be formed from a relatively flexible frame material and may be provided initially as an elongated rolled sheet of frame material or as several rolled sheets of material. The sheet of frame material is then bent across its width at at least one location to form the desired shape.

It is noted that in the context of this disclosure, each LED lighting device is referred to as having a single frame 110. However, it will be understood that some letters or shapes may have multiple frames, such as an internal and external frame for a ring letter or closed loop letter. This is visible in the Ds, O, R, and A of the examples shown. It is further understood that while the frame may be formed from a single elongated sheet of frame material, the frame may similarly be formed with multiple elongated sheets of frame material joining together at multiple seems. In such embodiments, a first end of a first sheet of frame material may meet a second end of a second sheet of frame material rather than a second end of the same sheet of frame material.

FIGS. 2-4 illustrate the preparation of one embodiment of an LED lighting assembly 200 for use in the method of this disclosure. Such a lighting assembly 200 typically has a front panel 210 and a frame 110. Once assembled, the frame 110 may extend past a front of the front panel 210, thereby forming a front lip 220. The front panel 210 has a front surface 300 facing outwards from the lighting assembly 200.

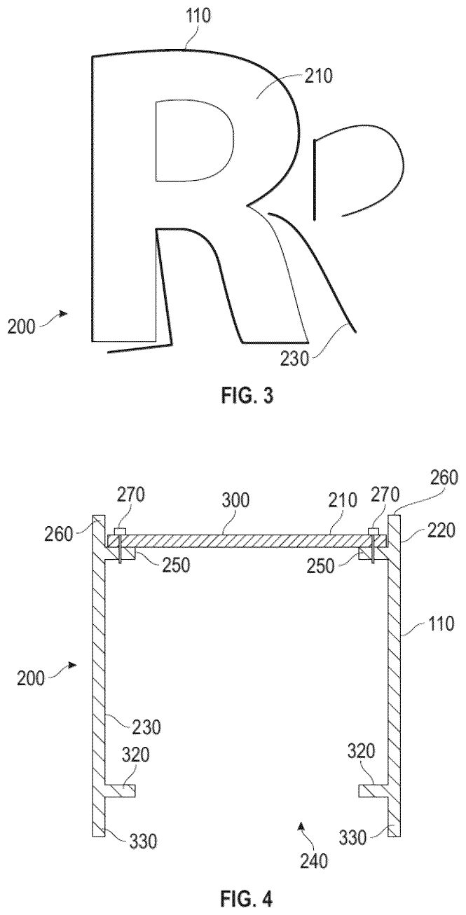

The frame 110 may be provided with a consistent cross section, as shown in FIGS. 2-4, taking the form of the shape desired. As such, the frame 110 may be an extrusion of material, or it may be a sheet of material formed into the desired shape. Alternatively, in some embodiments, the cross section of the frame 110 may be enlarged or shrunk over its thickness, such that the cross section consistently takes the desired shape, but in different sizes such that the overall device is tapered. In the embodiments shown, the frame 110 takes the form of an extrusion in the shape of the letter being formed, such as the R shown being assembled in FIG. 3.

The frame 110 is provided with an inner surface 230 that surrounds a lighting chamber 240 inside the LED lighting device 100. The frame 110 may be further provided with a front protrusion 250 which extends from the inner surface 230 of the frame 110. It will be understood that the front protrusion 250 is not part of the cross-sectional profile and thereby may extend from the substantially consistent profile provided.

As shown, in preparing the LED lighting assembly 200, the LED lighting device 100 may be provided with the front panel 210, which may function as a stabilizing panel comprising a first material. The front panel 210 is typically sized and shaped in concert with the frame 110, such that the front panel substantially corresponds to the size and shape of the inner surface 230 of the frame 110. Accordingly, where the frame 110 is in the shape of an R, as shown in FIG. 3, the front panel 210 would similarly be in the shape of an R and would be sized to abut the inner surface 230 of the frame on all sides when inserted into the frame.

The front panel 210 of the LED lighting assembly 200 would typically be formed from a mechanically rigid and robust material, such as a polycarbonate panel or other plastics. In some embodiments, the front panel 210 is transparent, or substantially transparent, in order to avoid impacting the quality of light being output from the front of the LED lighting device 100. In some embodiments, the front panel 210 is opaque or translucent white.

The front protrusion 250 is set back from a front edge 260 of the frame 110, and the front panel 210 is typically mechanically fastened to the front protrusion 250 at a plurality of locations adjacent the inner surface 230 of the frame. The mechanical fastening may be by way of, for example, nails 270, including micro-pins, or screws fixing the front panel 210 to the front protrusion 250 at various locations along an outer boundary of the front panel. Additionally, or instead of such nails 270 or screws, the front panel 210 may be fixed to the front protrusion 250 by adhesive.

Further, while both a front protrusion 250 and back protrusion 320, provided to support a potential backer panel, are shown, some embodiments may not include such a protrusion, and may instead, for example, directly fix the front panel 210 to the inner surface 230 of the frame 110. Similarly, the entire LED lighting assembly may be assembled as a single unit.

During use, the LED lighting device 100 is further provided with at least one LED lighting module behind the front panel 210 and directed towards the front panel. Such an LED lighting module is typically mounted on a backer panel, and the LED lighting modules are located within the lighting chamber 240 of the frame 110 and face the front panel 210. As such, any light exiting the LED lighting module is directed towards and passes through the front panel 210.

As noted above, the LED lighting assembly 200 may be further provided with a back protrusion 320 extending from the inner surface 230 and set back from a back edge 330 of the frame 110 in order to support such a backer panel.

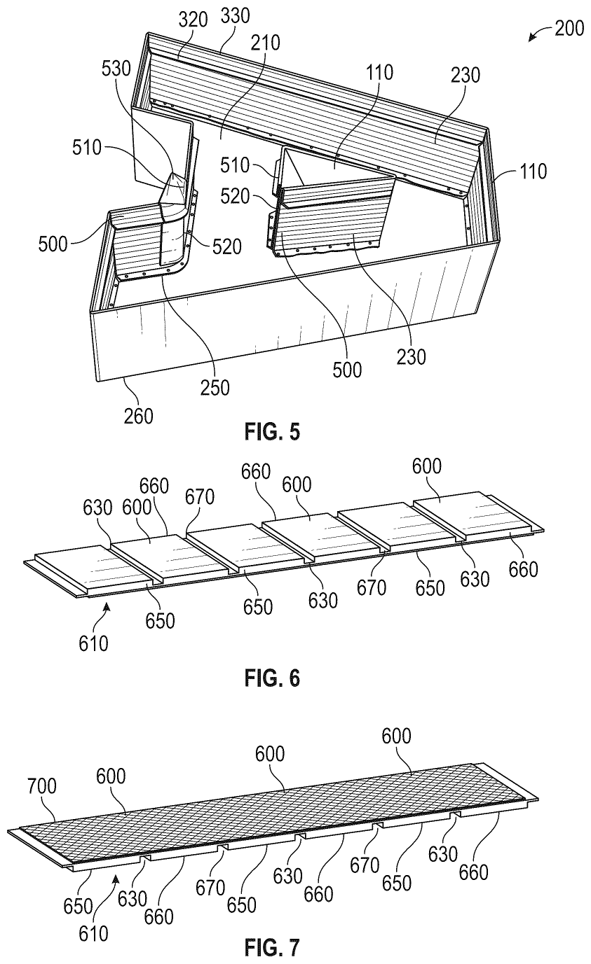

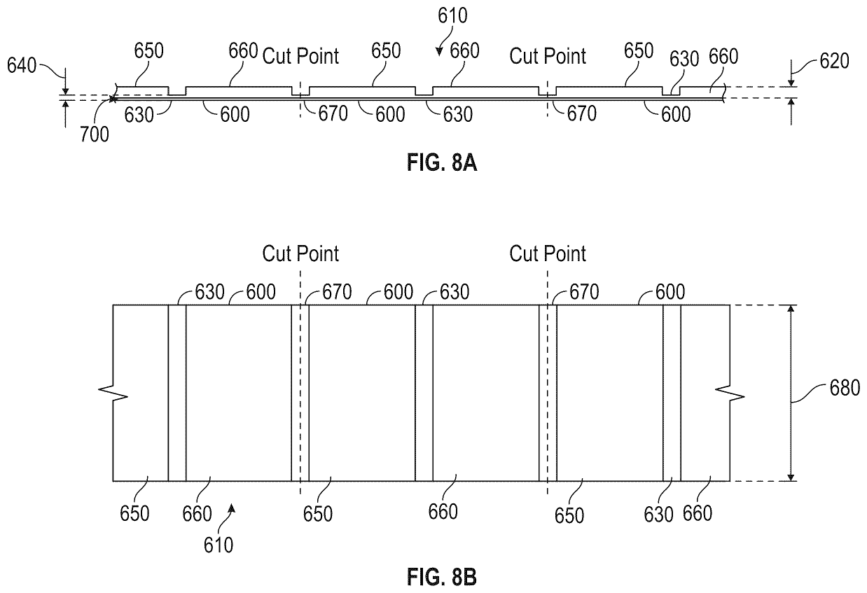

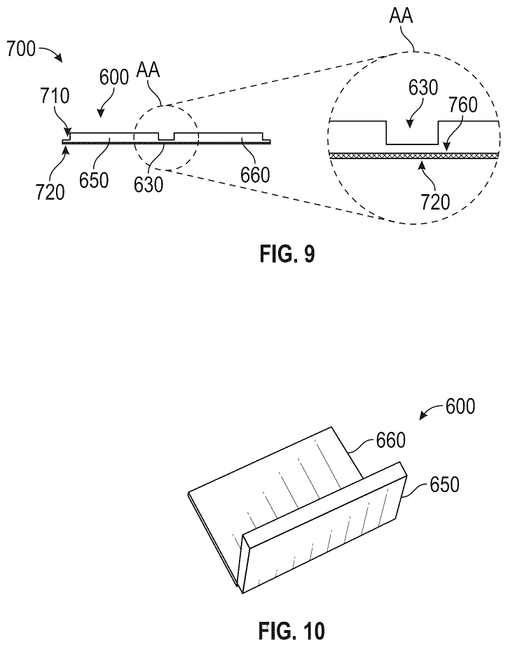

FIG. 5 shows a frame 110 for an LED lighting assembly 200 in accordance with this disclosure. FIGS. 6, 7, 8A, and 8B show a sheet of joint material 610 for use in the method described. FIG. 9 shows a detail view of a groove 630 cut into the sheet of joint material 600 of FIG. 6.

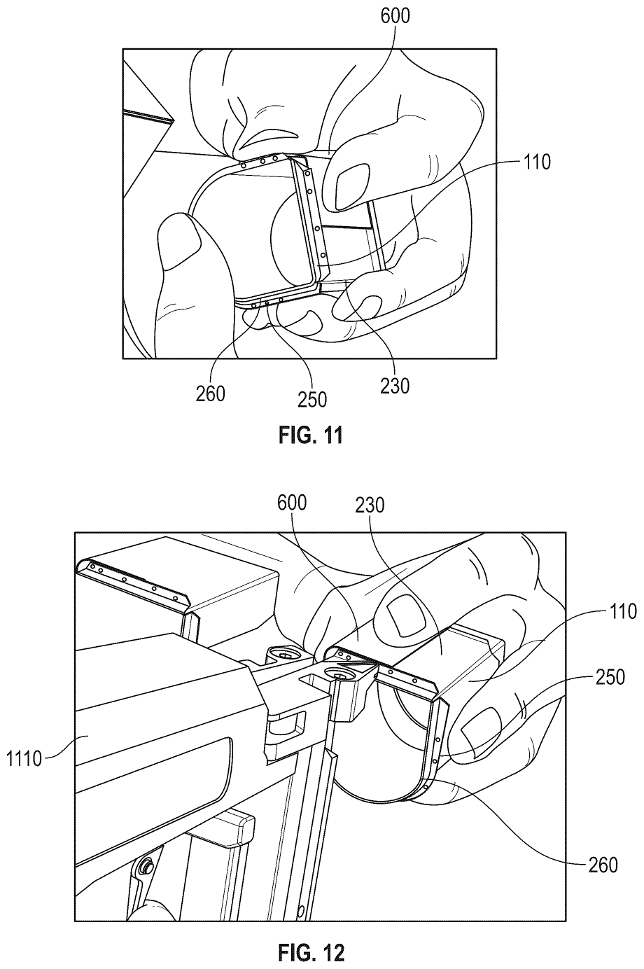

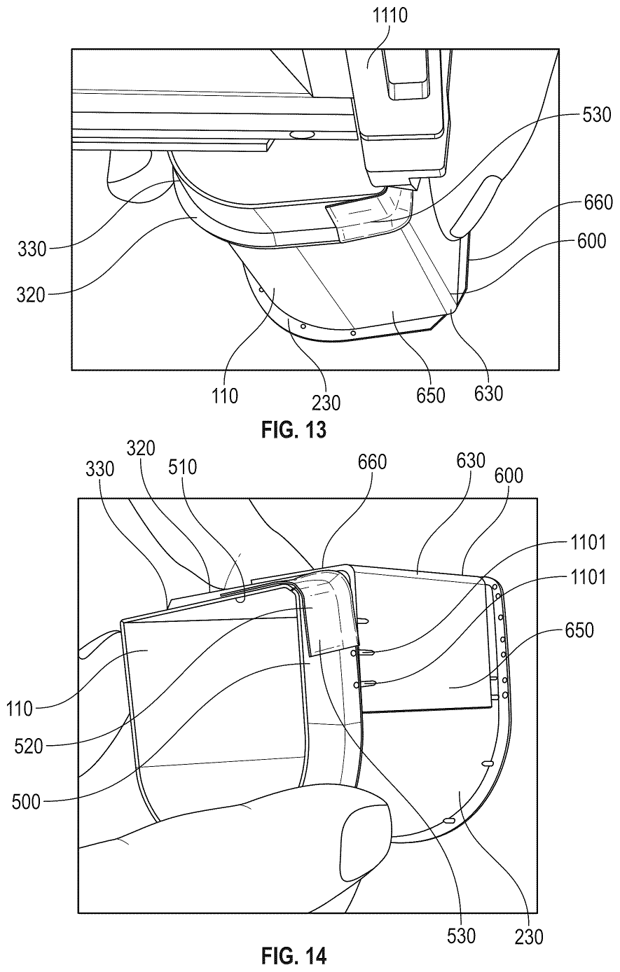

FIG. 10 shows a portion of the sheet of joint material 610 of FIG. 6 cut to size and bent to shape to define a joint fixation element 600. FIG. 11 shows the portion of the sheet of joint material 610 of FIG. 10 positioned on the frame 110. FIGS. 12 and 13 show the securing of the portion of the sheet of joint material 610 shaped into a joint fixation element 600, as shown in FIG. 10, to the frame 110.

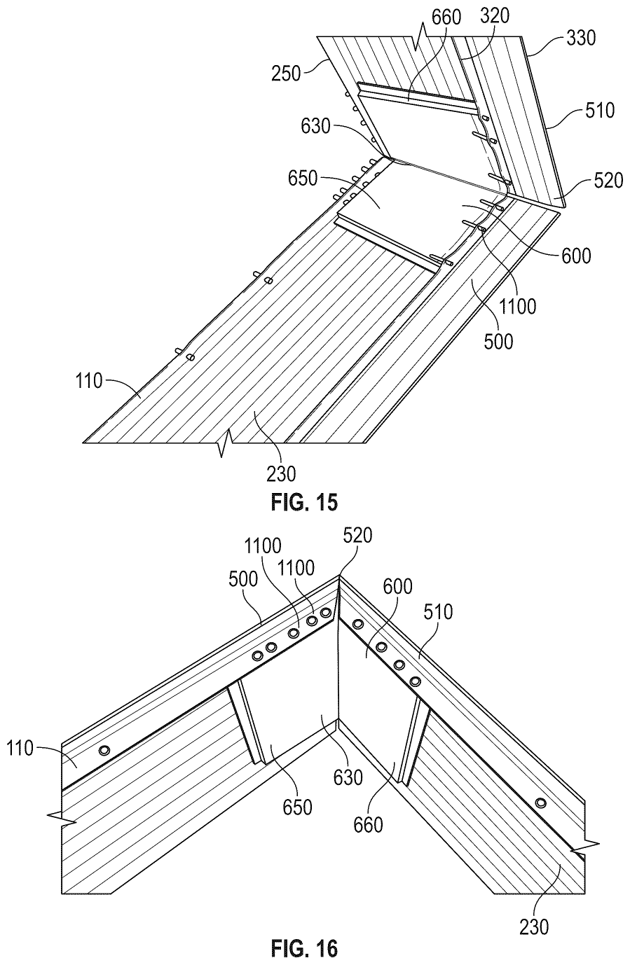

FIG. 14 shows the portion of the sheet of joint material 610 formed into a joint fixation element 600 and secured to the frame 110. FIGS. 15 and 16 show an additional instance of joint material 610 formed into a joint fixation element 600 and secured to a frame 110 in accordance with this disclosure.

The method for assembling an LED lighting assembly 200 then includes first providing the frame for the LED lighting assembly. The frame 110 is generally formed from and comprises at least one elongated sheet of frame material. The elongated sheet 110 is then bent across its width 680 at at least one location to form the shape. Accordingly, an outer boundary of the “A” shown in FIG. 5 may be formed from a single elongated sheet of aluminum bent into shape. As noted above, for some letters, such as the “A” shown, an additional inner boundary, formed from an additional elongated sheet of frame material 110 is required to define a closed loop of the letter.

Once bent into shape, a first end 500 of the sheet frame material defining the frame 110 meets a second end 510 of the sheet of frame material at a seem 520. Typically, the first end 500 meets the second end 510 at an angle, such that the first end approaches the seem at an angle relative to the second end. Accordingly, the two ends 500, 510 of the sheet of frame material defining the frame 100 meet at a corner.

As noted above, the frame 110 has at least one protrusion, with the embodiment shown having a front protrusion 250 and a back protrusion 320. Such protrusions 250, 320 extend from an inner surface 230 of the frame 110 defined by the sheet of frame material towards an inside of the shape adjacent a front edge 260 or a back edge 330 of the shape respectively.

In some embodiments, as noted above, the frame 110 may be mated to a front panel 210, as shown in FIG. 4, which would then fix the shape of the elongated sheet of frame material. Alternatively, or in addition, the seems 520 may be initially secured with tape 530, as shown. The tape 530 applied to the seems 520 would then be trimmed such that they don't extend beyond the front or back edge 260, 330 of the frame 110, and would then be overlayed with a joint fixation element 600 formed from a sheet of joint material 610. Accordingly, as a first step, the seem 520 may be taped 530 and then trimmed.

The joint material 610 is then provided as a sheet of joint material, typically polycarbonate or other clear polymer or other plastics. The joint fixation element 600 may, itself, be the sheet of joint material 610, or the joint material may be provided in sheets having multiple such joint fixation elements 600. In the embodiment of FIGS. 6 and 7, the sheet of joint material 610 contains 3 separable joint fixation elements 600.

The sheet of joint material 610 has a first thickness 620, which may be, e.g., 1-3 mm. The sheet of joint material 610 is then provided with a groove 630 defining a reduced second thickness 640 smaller than the first thickness 620. The groove 630 then divides the sheet of joint material 610 into a first segment 650 of the sheet of joint material and a second segment 660 of the sheet of joint material. As shown, where multiple joint fixation elements 600 are provided on a single sheet 610, each fixation element is then provided with a groove 630, and each element is then divided into a first segment 650 and a second segment 660.

As noted below, the first thickness 620 is typically sufficient to receive and retain a fastener 1100 applied directly to the thickness of the corresponding joint fixation element 600. The second thickness 640 would be too thin to receive such a fastener, and would allow the segments 650, 660 to pivot relative to each other at the groove 630.

The joint fixation element 600 or the sheet of joint material 610 is then bent at the groove 630. The first segment 650 is then positioned adjacent the first end 500 of the sheet of frame material and the second segment 660 is positioned adjacent the second end 510 of the sheet of frame material. Typically, the joint fixation element 600 can be bent roughly to shape and can then be adjusted upon application to the seem 520. Accordingly, the joint fixation element 600 need not be preemptively bent precisely to the required angle. Further, because the joint fixation element 600 does not require precise preemptive bending, it could be bent during the application to the seem 520.

The joint fixation element 600 or the sheet of joint material 610 is then secured to the frame 110 at each of the first and second ends 500, 510 of the sheet of frame material. This may be done using a plurality of fasteners 1100, such as micro-pin nails applied with a nail gun 1110, for example. Each of the plurality of fasteners 1100 then pierces the corresponding protrusion 250, 320 of the frame 110 and retains the corresponding segment of the first segment 650 and the second segment 660 relative to the protrusion.

Where separate front and back protrusions 250, 320 are provided, fasteners 1100 are typically driven through both the front and back. As such, the width 680 of the fixation element may correspond substantially to a distance between the front and back protrusions 250, 320.

Typically, the fastener 1100 is driven through the protrusion 250, 320 and enters the thickness 620 of the joint fixation element 600. In some embodiments, or in some instances, the fastener may be driven outside of the thickness 620, but sufficiently close to retain the joint fixation element 600 at the inner surface 230 of the frame 110.

As shown, where the sheet of joint material 610 includes multiple joint fixation elements 600, the individual elements may be separated by secondary grooves 670 which may be used to score the material 610 for easy separation.

The sheet of joint material 610 may include or be laminated with at least one layer of opaque material 700, which may be vinyl. The opaque material may be used to control light both inside and outside the frame. Accordingly, the opaque material may be used to laminate the joint material 610 on a surface opposite the groove 630 and applied to the inner surface 230 of the frame 110.

An inward facing surface 710 of the opaque material 700 may then be white or silver, and an outward facing surface 720 of the opaque material may then be black. The inward facing surface 710 is typically applied directly to the joint material 610, such as polycarbonate. Accordingly, where the joint material 610 is transparent or translucent, the white or silver surface 710 is visible through the material. Accordingly, the apparent color of the joint material 610 when viewed from inside the frame 110 is white or silver, which improves the quality of reflected light within the frame. In contrast, the apparent color of the joint material 610 when viewed from outside the frame 110 is black or another dark color, which blocks or minimizes light leakage through the seem 520.

In some embodiments, a white or silver inner layer of opaque material, such as vinyl is applied and a black outer layer of opaque material is separately applied. In some embodiments, a single layer of opaque material is provided that is white or silver on one side and black on another. In still other embodiments, a white or silver material is used without a black outer surface.

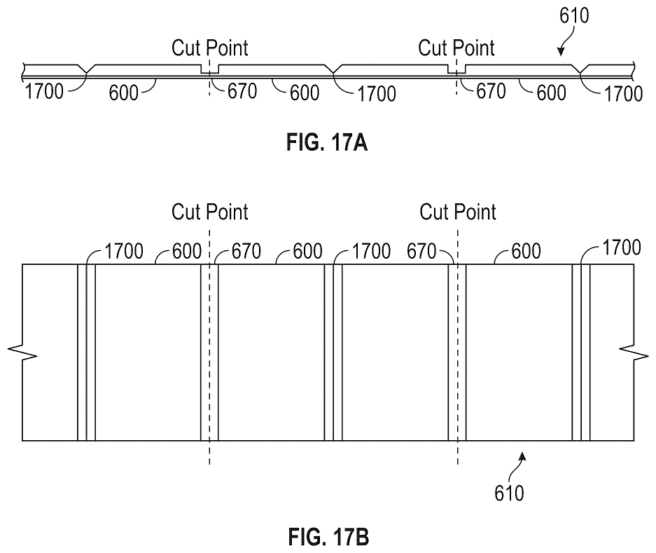

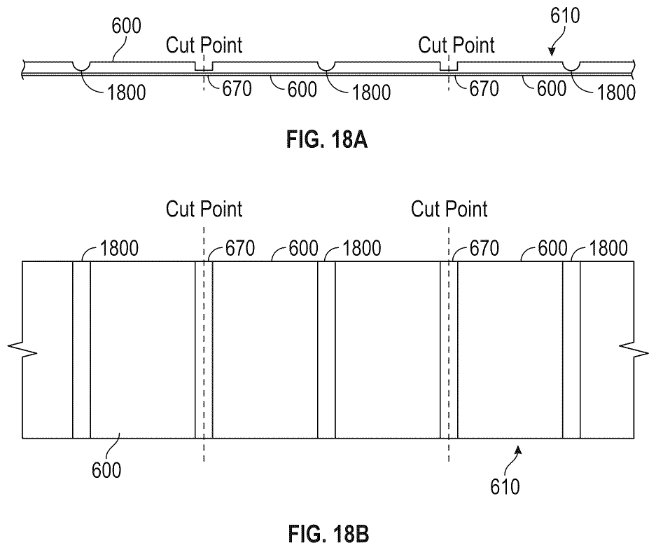

FIGS. 17A, B and 18A, B show alternate embodiments of joint material 610 for use in the method described. As shown, the individual joint fixation elements 600 may be provided with different shaped grooves 1700, 1800. Accordingly, the grooves may be rectangular 630 or then may be round 1700 or V-shaped 1800. Such groove profiles may have different limitations in terms of how far they can be bent, and how precisely such bends will be located within the corresponding groove 630, 1700, 1800. In such alternate embodiments, the secondary grooves 670 may continue to be rectangular, as shown, or they may be shaped similarly to the corresponding grooves 630, 1700, 1800. The various grooves 630, 1700, 1800 may take other shapes as well. This decision may be made based on ease of manufacturing.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A method for assembling an LED lighting device comprising:
providing a frame for the LED lighting device, the frame comprising at least one elongated sheet of frame material bent across at its width at at least one location to form a shape,
wherein a first end of the sheet of frame material meets a second end of the sheet of frame material at a seem,
wherein the first end of the sheet of frame material approaches the seem at an angle relative to the second end of the sheet of frame material;
wherein the frame has at least one protrusion extending from an inner surface defined by the sheet of frame material towards an inside of the shape adjacent a front or back edge of the shape;
providing a sheet of joint material having a first thickness;
providing a groove in the sheet of joint material, the groove defining a reduced second thickness and dividing a first segment of the sheet of joint material and a second segment of the sheet of joint material;
bending the sheet of joint material at the groove and positioning the first segment adjacent the first end of the sheet of frame material and positioning the second segment adjacent the second end of the sheet of frame material; and
securing the sheet of joint material on each of the first and second ends of the sheet of frame material with a plurality of fasteners,
wherein each of the plurality of fasteners pierces the protrusion of the frame and retains a corresponding segment of the first segment and the second segment relative to the protrusion.

2. The method of claim 1 wherein the shape is a shape of a letter.

3. The method of claim 2 wherein the frame material is a flexible metal, and wherein the metal is bent across its width at a plurality of locations to define the shape of the letter.

4. The method of claim 1 wherein the frame material is aluminum.

5. The method of claim 1 wherein the joint material is polycarbonate.

6. The method of claim 5 wherein the joint material is laminated on a surface opposite the groove with at least one layer of opaque material.

7. The method of claim 6 wherein the opaque material is vinyl.

8. The method of claim 6 wherein an inward facing surface of the opaque material is white or silver, and wherein an outward facing surface of the opaque material is black.

9. The method of claim 8 wherein the joint material is translucent.

10. The method of claim 5 wherein the groove is rectangular, round, or V-shaped.

11. The method of claim 1 wherein the plurality of fasteners are micro-pin nails.

12. The method of claim 1 wherein the first thickness is sufficient to receive the micro-pin nails but the second thickness is insufficient to receive the micro-pin nails.

13. The method of claim 1 further comprising applying a layer of tape to the seem prior to securing the sheet of joint material.

14. The method of claim 1 wherein the frame has a substantially consistent cross-sectional profile matching the shape other than the at least one protrusion, and wherein the at least one protrusion comprises a first protrusion extending from the inner surface towards the inside of the shape adjacent the front edge of the shape and a second protrusion extending from the inner surface towards the inside of the shape adjacent the back edge of the shape, and wherein fasteners are applied at each of the first and second protrusion.

15. The method of claim 1 wherein the frame houses at least one LED lighting module.
